(19) United States
(12) Patent Application Publication
(10) Pub. No.: US 2025/0392151 A1
(43) Pub. Date: Dec. 25, 2025

(54) CIRCUITRY FOR CHARGING A BOOTSTRAP CAPACITOR

(71) Applicant: Cirrus Logic International Semiconductor Ltd., Edinburgh (GB)

(72) Inventors: David J. SMITH, Edinburgh (GB); Nasir ALI, Edinburgh (GB); Hamed SADATI, Swindon (GB); Paulius CEREBIEJUS, Edinburgh (GB)

(73) Assignee: Cirrus Logic International Semiconductor Ltd., Edinburgh (GB)

(21) Appl. No.: 19/011,831

(22) Filed: Jan. 7, 2025

Related U.S. Application Data
(60) Provisional application No. 63/662,494, filed on Jun. 21, 2024.

(51) Int. Cl. H02J 7/00; H02J 7/34

(52) U.S. Cl. CPC H02J 7/007182; H02J 7/00718; H02J 7/345; H02J 2207/50

(57) ABSTRACT

Charging circuitry for charging a bootstrap capacitor that provides a gate drive voltage to a high-side switch of switching circuitry, wherein a first terminal of the bootstrap capacitor receives a variable voltage, the charging circuitry comprising: current source circuitry configured to supply a charging current to the bootstrap capacitor; a charging switch for selectively coupling the current generator circuitry to the bootstrap capacitor to permit charging of the bootstrap capacitor by the current generator circuitry; and control circuitry configured to control operation of the charging switch to charge the bootstrap capacitor to at least a predefined target voltage, wherein the predefined target voltage is referenced to the variable voltage.

### FIELD OF THE INVENTION

The present disclosure relates to circuitry for charging a bootstrap capacitor.

### BACKGROUND

In many switching circuits, including for example switching power converters, switching amplifiers and the like, the switching circuit includes a high-side switch which, when closed (switched on), connects a node of the circuit to another node or terminal of the circuit that is at a relatively high voltage level. In many cases the high-side switch is an NMOS MOSFET device.

### SUMMARY

According to a first aspect, the invention provides charging circuitry for charging a bootstrap capacitor that provides a gate drive voltage to a high-side switch of switching circuitry, wherein a first terminal of the bootstrap capacitor receives a variable voltage, the charging circuitry comprising: current source circuitry configured to supply a charging current to the bootstrap capacitor; a charging switch for selectively coupling the current generator circuitry to the bootstrap capacitor to permit charging of the bootstrap capacitor by the current generator circuitry; and control circuitry configured to control operation of the charging switch to charge the bootstrap capacitor to at least a predefined target voltage, wherein the predefined target voltage is referenced to the variable voltage.

The control circuitry may comprise comparator circuitry configured to compare a signal indicative of a voltage at a second terminal of the bootstrap capacitor to a reference signal indicative of the predefined target voltage and to output a comparator output signal based on the comparison. Responsive to the comparator circuitry outputting a comparator output signal indicative that the voltage at the second terminal of the bootstrap capacitor is less than the predefined target voltage, the control circuitry may cause the charging switch to close to permit charging of the bootstrap capacitor by the current generator circuitry. Responsive to the comparator circuitry outputting a comparator output signal indicative that the voltage at the second terminal of the bootstrap capacitor is equal to or greater than the predefined target voltage, the control circuitry may cause the charging switch to open to prevent charging of the bootstrap capacitor by the current generator circuitry.

The signal indicative of the voltage at the second terminal of the bootstrap capacitor may comprise the voltage at the second terminal of the bootstrap capacitor. The reference signal indicative of the predefined target voltage may comprise the predefined target voltage.

The charging circuitry may further comprise a comparator switch for coupling a first input of the comparator circuitry to the second terminal of the bootstrap capacitor. Operation of the comparator switch may be synchronised with an operational cycle of the switching circuitry.

The control circuitry may further comprise on-off controller circuitry configured to receive the comparator output signal and to output a pulse of a duration equal to a period for which the comparator output signal is indicative that the voltage at the second terminal of the bootstrap capacitor is less than the predefined target voltage. The control circuitry may be operative to cause the charging switch to close for the duration of the pulse.

The on-off controller circuitry may be further configured to receive a signal indicative of a minimum charging pulse duration for the bootstrap capacitor and to output a pulse of a duration equal to the longer of: a period for which the comparator output signal is indicative that the voltage at the second terminal of the bootstrap capacitor is less than the predefined target voltage; and the minimum charging pulse duration.

The control circuitry may further comprise time to voltage converter circuitry configured to: receive the pulse output by the on-off control circuitry; and output a voltage indicative of the duration of the pulse for controlling a magnitude of the charging current output by the current source circuitry.

The charging circuitry may further comprise a comparator switch for coupling a first input of the comparator circuitry to the second terminal of the bootstrap capacitor. Operation of the comparator switch may be synchronised with an operational cycle of the switching circuitry. The time to voltage converter may be configured to increase the charging current output by the current source circuitry responsive to a reduction in a duration of a charging period of the bootstrap capacitor in the operational cycle of the switching circuitry.

The control circuitry may further comprise hysteresis buffer circuitry configured to receive the voltage output by the time to voltage converter circuitry.

The charging circuitry may further comprise an overvoltage protection subsystem, the overvoltage protection subsystem comprising: overvoltage detection circuitry configured to compare a signal indicative of a voltage at a second terminal of the bootstrap capacitor to an overvoltage reference signal; and overvoltage clamp circuitry operative to couple the second terminal of the bootstrap capacitor to a reference voltage supply rail.

According to a second aspect, the invention provides switching circuitry comprising the charging circuitry the first aspect, wherein the switching circuitry comprises switching power converter circuitry, switching boost converter circuitry, switching buck converter circuitry, switching buck-boost converter circuitry, switching AC-DC converter circuitry, switching DC-AC converter circuitry, or switching amplifier circuitry.

According to a third aspect, the invention provides a host device comprising the charging circuitry of the first aspect.

The host device may comprise, for example, a laptop, notebook, netbook or tablet computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console a VR or AR device, a mobile telephone, a portable audio player or other portable device.

According to a fourth aspect, the invention provides an integrated circuit comprising the charging circuitry of the first aspect.

According to a fifth aspect, the invention provides charging circuitry for charging a bootstrap capacitor of switching power converter circuitry, wherein the charging circuitry comprises control circuitry operative to synchronise charging of the bootstrap capacitor with an operational cycle of the switching power converter circuitry.

According to a sixth aspect, the invention provides charging circuitry for charging a bootstrap capacitor of switching circuitry, the charging circuitry comprising adaptive charge pump circuitry configured to adapt a level of charge supplied to the bootstrap capacitor according to a duty cycle of the switching circuitry.

According to a seventh aspect, the invention provides charging circuitry for charging a bootstrap capacitor of switching circuitry, the charging circuitry comprising: a controllable current source for supplying a charging current to the bootstrap capacitor; and control circuitry, wherein the control circuitry is configured to control the controllable current source based on a duty cycle of the switching circuitry to ensure a minimum level of charge is supplied to the bootstrap capacitor per operational cycle of the switching circuitry.

According to an eighth aspect, the invention provides charging circuitry for charging a bootstrap capacitor of switching circuitry, the charging circuitry comprising control circuitry operative to supply one charging pulse to the bootstrap capacitor per operational cycle of the switching circuitry.

The control circuitry may be operative to supply one charging pulse of at least a minimum duration to the bootstrap capacitor per operational cycle of the switching circuitry.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the invention will now be described, strictly by way of example only, with reference to the accompanying drawings, of which:

FIG. 1 is a simplified schematic representation of example boost converter circuitry; and

FIG. 2 is a schematic representation of example circuitry for charging a bootstrap capacitor in accordance with the present disclosure.

### DETAILED DESCRIPTION

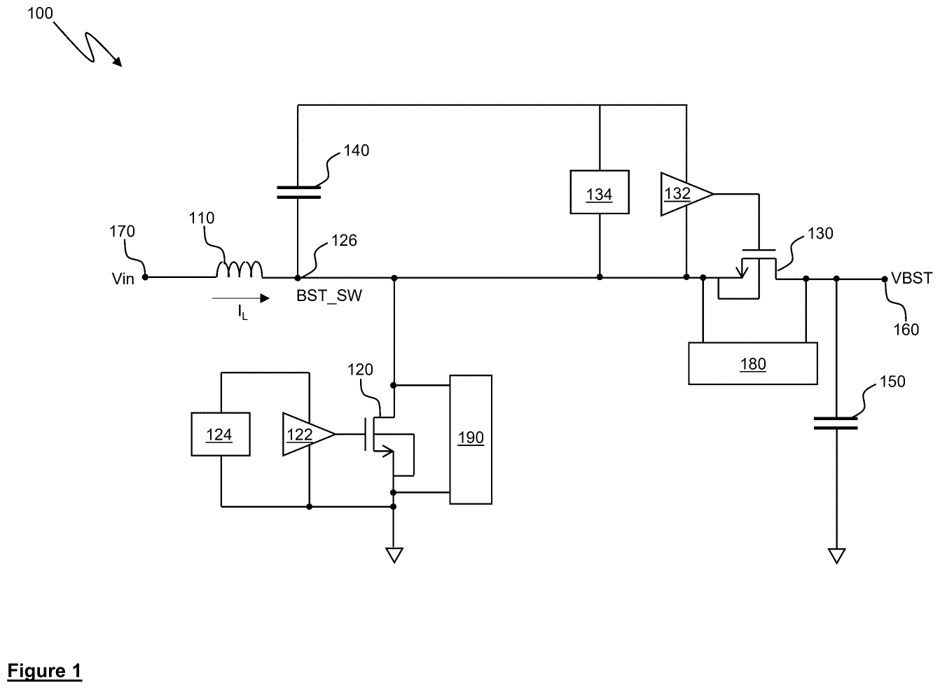

FIG. 1 is a simplified schematic representation of example boost converter circuitry.

The boost converter circuitry (shown generally at 100 in FIG. 1) includes an inductor 110, a low-side switch 120 (which in this example is an n-channel MOSFET), low-side gate driver circuitry 122 for supplying a drive voltage to a gate of the low-side switch 120, and low-side supply generator circuitry 124 configured to provide a supply voltage to the low-side gate driver circuitry 122. The boost converter circuitry 100 further includes a high-side switch 130 (which in this example is also an n-channel MOSFET), high-side gate driver circuitry 132 for supplying a drive voltage to a gate of the high-side switch 130, and high-side supply generator circuitry 134 configured to provide a supply voltage to the high-side gate driver circuitry 132.

The boost converter circuitry 100 further includes a bootstrap capacitor 140 coupled in parallel with the high-side supply generator circuitry 134 to supply a bootstrap voltage to the high-side gate driver circuitry 132. A first terminal of the bootstrap capacitor 140 is coupled to a node 126 between the inductor and the low-side switch 120.

The boost converter circuitry further includes a reservoir capacitor 150 coupled between an output node 160 of the boost converter circuitry 100 and a ground or other reference voltage supply rail (hereinafter referred to as ground, for simplicity).

The inductor 110 is coupled in series between an input node 170 at which an input voltage Vin to the boost converter circuitry 100 is received and a drain terminal of the low-side switch 120. A source terminal of the low-side switch 120 is coupled to ground, and a gate terminal of the low-side switch 120 is coupled to an output of the low-side gate driver circuitry 122.

A source terminal of the high-side switch 130 is coupled to the inductor 110 and a drain terminal of the high-side switch 130 is coupled to the output node 160, at which an output voltage VBST of the boost converter circuitry 100 is supplied. A gate terminal of the high-side switch 130 is coupled to an output of the high-side driver circuitry 132.

In operation of the boost converter circuitry 100, the low-side switch 120 and the high-side switch 130 are controlled to switch on alternately so as to repeatedly couple one terminal of the inductor 110 to ground and then to the output node 160, such that energy can be transferred from the inductor 110 to the reservoir capacitor 150 to increase the output voltage VBST across the reservoir capacitor 150 to a level that is greater than the input voltage Vin.

In a first, charging, phase of operation of the circuitry 100, control circuitry (not shown in FIG. 1 for simplicity) outputs control signals to the low-side and high-side switches 120, 130 to switch the low-side switch 120 on, and to switch the high-side switch 130 off. Thus, during the charging phase, a current path exists from the input node 170 to ground through the inductor 110, and an increasing current IL flows through the inductor 110. As a result of the increasing inductor current IL, the inductor stores energy by generating a magnetic field.

In a second, discharging, phase, of operation of the circuitry 100, the control circuitry outputs control signals to the low-side and high-side switches 120, 130 to switch the low-side switch 120 off, and to switch the high-side switch 130 on. Thus, during the discharging phase, current can no longer flow through the inductor 110 to ground through the low-side switch 120. The current in the inductor 110 must keep flowing, and therefore flows into the reservoir capacitor 150, causing the voltage VBST across the reservoir capacitor 150 to increase. If VBST is smaller than Vin the current in the inductor 110 will continue to increase, hence charging the reservoir capacitor 150. If VBST is greater than Vin the current in the inductor 110 will start decreasing, but because the current is still positive the voltage VBST across the reservoir capacitor 150 will continue to increase further.

By repeating the charging phase and the discharging phase a number of times, the reservoir capacitor 150 can be charged to a level at which the voltage VBST across the reservoir capacitor 150 is greater than the input voltage Vin and is thus suitable for supplying downstream components or subsystems such as amplifier circuitry or the like that require a voltage greater voltage than Vin.

When the node 126 between the inductor 110 and the low-side switch 120 is low (when the low-side switch 120 is switched on and the high-side switch 130 is switched off, in the charging phase), the bootstrap capacitor 140 is charged by the high-side supply generator circuitry 134. When the low-side switch 120 is switched off and the high-side switch 130 is switched on in the discharging phase, the inductor current IL drives a voltage at the node 126 to VBST. The voltage across the bootstrap capacitor 140 will follow the voltage at the node 126, such that the voltage across the bootstrap capacitor 140 is applied across the gate-source of the high-side switch 130.

Accurate sensing and regulation of the inductor current IL is desirable in boost converter circuitry 100 of the kind shown in FIG. 1, to optimise control of the boost converter circuitry 100. The inductor current IL during the discharge phase of operation of the boost converter circuitry can be determined based on the current through the high-side switch 130.

The boost converter circuitry 100 of FIG. 1 includes current monitor circuitry 180 configured to monitor current through the high-side switch 130. The current monitor circuitry may comprise, for example, a plurality of replica devices (e.g. smaller replicas of the high-side switch 130) coupled to the high-side switch 130, and the current through the high-side switch 130 can be derived from the current through the replica devices. Similar current monitor circuitry 190 may be provided for monitoring current through the low-side switch 120. Examples of switching circuits with current monitor circuitry for monitoring current through a high-side switch are described in U.S. provisional patent application No. 63/595,833 and U.S. patent application Ser. No. 18/590,241, the contents of which are incorporated by reference herein.

Replica-based current monitor circuitry of the kind described in in U.S. provisional patent application No. 63/595,833 and U.S. patent application Ser. No. 18/590,241 provides a low-power means for monitoring current through the high-side switch 130 (and the low-side switch 120). However, such replica-based current monitor circuitry may suffer from low accuracy, for example due to drift in a gain of the replica devices.

In replica-based current monitor circuitry, a proportion of a current through a device being monitored (such as the high-side switch 130 of the boost converter circuitry 100 of FIG. 1) flows through a replica of the device being monitored. The replica may be a smaller replica of the device being monitored. Thus, a replica device for replica-based current monitoring circuitry for the high-side switch 130 of the boost converter circuitry 100 of FIG. 1, would be a smaller replica of the high-side switch 130, e.g. an n-channel MOSFET that is smaller than an n-channel MOSFET implementing the high-side switch 130.

The current through the device being monitored is determined (by current sensing circuitry downstream of the replica device in the replica-based current monitoring circuitry) by multiplying the current through the replica device by a gain of the replica device. The gain of the replica device is proportional to (e.g. equal to) a ratio of an on-resistance of the replica device to a resistance of the device being monitored, i.e. G_{replica} α R_{on(replica)}/Rₒₙ₍ₘₐᵢₙ₎, where Rₒₙ₍ₘₐᵢₙ₎ is the on-resistance of the device being monitored (e.g. the high-side switch 130) and R_{on(replica)} is the on-resistance of the replica device.

The on-resistance of the device being monitored is dependent upon the gate-source voltage of the device being monitored. The current sensing circuitry of replica-based current monitoring circuitry is typically calibrated during or after a manufacturing process with a value of the gain of the replica device determined for a particular gate-source voltage supplied to the device being monitored. If, in operation of the circuitry containing the device being monitored, the gate-source voltage of the device being monitored differs from the particular gate-source voltage supplied during calibration, the gain of the replica device will differ from the value determined during calibration. This is known as gain drift, and can give rise to error in the measured current through the device being monitored.

To improve the accuracy of replica-based current monitoring circuitry, it would be desirable to ensure that the gate-source voltage applied to the device being monitored during operation of the circuitry containing the device being monitored remains the same as (or as close as possible to) the gate-source voltage applied during calibration, to minimise gain drift in a replica device.

As the bootstrap capacitor 140 can only be charged when the low-side switch 120 is switched on and the high-side switch 130 is switched off, at extremes of duty cycle, an amount of time available for charging the bootstrap capacitor 140 is limited, which has the effect of limiting the gate drive voltage of the high-side switch 130.

Additionally, the drain-source resistance of the low-side switch 120 can vary with temperature, which affects the inductor current IL during the charging phase of operation of the boost converter circuitry 100. As a result of such factors, the voltage BST_SW at the node 126 can vary significantly (e.g. between 0 volts and 1 volt) in the charging phase of operation of the boost converter circuitry 100 (i.e. while the low-side switch 120 is switched on).

The present disclosure provides charging circuitry that accurately charges the bootstrap capacitor 140 to a predefined level while the high-side switch 130 is switched off. Charging the bootstrap capacitor 140 in this way may reduce inaccuracy in a current sensing operation that senses current through the high-side switch 130 using a replica-based current monitor circuitry, as the bootstrap capacitor 140 is able to supply an accurate gate-source voltage to the switch being monitored (e.g. the high-side switch 130) that is equal or close to the gate-source voltage supplied to the switch being monitored during calibration, thus minimising or at least reducing gain drift in a replica device of the replica-based current monitoring circuitry.

The charging circuitry may be operative to charge the bootstrap capacitor 140 in synchronisation with an operational cycle of the boost converter circuitry 100.

In some examples, the charging circuitry may supply one charging pulse to the bootstrap capacitor 140 per operational cycle of the boost converter circuitry 100. In some examples the charging circuitry may charge the bootstrap capacitor 140 for at least a minimum charging duration per operational cycle of the boost converter circuitry 100. For example, the charging circuitry may supply one charging pulse of at least a minimum duration to the bootstrap capacitor 140 per operational cycle of the boost converter circuitry 100. In some examples the charging circuitry may be operative to adapt the amount of charge supplied to the bootstrap capacitor 140 per operational cycle of the boost converter circuitry 100, based on the time available for charging the bootstrap capacitor 140.

Adapting the amount of charge supplied to the bootstrap capacitor 140 in this way may allow the charging circuitry to compensate for a change in the time available for charging the bootstrap capacitor 140 that may arise as a result of a change in a duty cycle of the boost converter circuitry 100. For example, the charging circuitry may be operative to increase the amount of charge supplied to the bootstrap capacitor 140 (e.g. by increasing a charging current supplied to the bootstrap capacitor 140) in a next operational cycle of the boost converter circuitry 100 following a reduction in the duty cycle of the boost converter circuitry 100, and may be operative to decrease the amount of charge supplied to the bootstrap capacitor 140 (e.g. by decreasing the charging current supplied to the bootstrap capacitor 140) in a next operational cycle of the boost converter circuitry 100 following a decrease in the duty cycle of the boost converter circuitry 100.

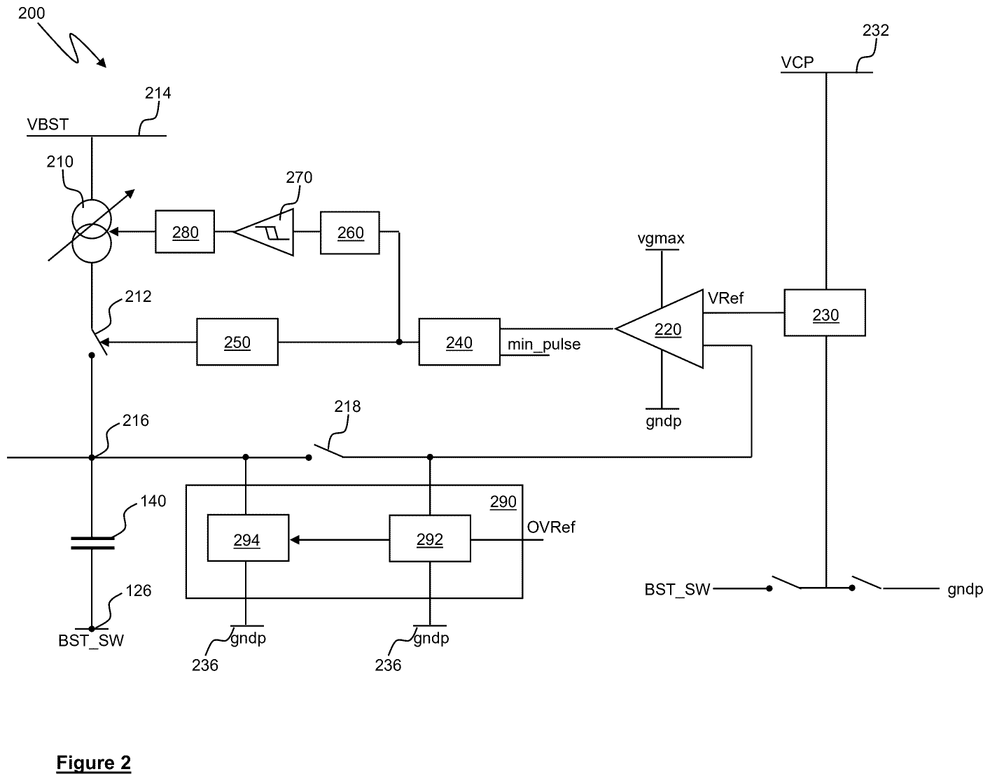

FIG. 2 is a schematic representation of example circuitry for charging a bootstrap capacitor in accordance with the present disclosure.

The circuitry, shown generally at 200 in FIG. 2, comprises controllable high-impedance current source circuitry 210 and a charging switch 212 coupled in series with the bootstrap capacitor 140 between a first supply voltage rail 214 that receives the output voltage VBST of the boost converter circuitry 100 of FIG. 1 and the node 126. It will be appreciated, however, that the first supply voltage rail 214 could receive an alternative supply voltage (i.e. a different supply voltage than the output voltage VBST of the boost converter circuitry 100), provided that the alternative supply voltage is equal to or greater than the desired gate-source voltage of the high-side switch 130. For example, if the high-side switch 130 required a gate drive voltage of 3V, an alternative supply voltage of 5V would be sufficient.

As discussed above, the node 126 is a floating node, such that a voltage BST_SW at the node 126 when the low-side switch 120 of the boost converter circuitry 100 is switched on is variable, e.g. between 0 volts and 1 volt.

A node 216 between the bootstrap capacitor 140 and the charging switch 212 is coupled, via a switch 218, to a first input of comparator circuitry 220. A second input of the comparator circuitry is coupled to an output of reference voltage generator circuitry 230 so as to receive a reference voltage VRef generated by the reference voltage generator circuitry 230.

The reference voltage generator circuitry 230 is coupled between a second positive power supply voltage rail 232 that supplies a positive supply voltage VCP (which is different from the output voltage VBST of the boost converter circuitry 100 or the alternative supply voltage at the first supply voltage rail 214) and the node 126. The second positive supply rail may receive the positive supply voltage VCP from supply voltage generator circuitry such as charge pump based supply voltage generator circuitry, for example. The reference voltage VRef output by the reference voltage generator circuitry 230 to the comparator circuitry 220 is referenced to (e.g. tracks) either the voltage BST_SW at the node 126 or a reference voltage (e.g. ground potential) gndp at a reference voltage rail 236, according to a phase of operation of the boost converter circuitry 100. During the charging phase of operation of the boost converter circuitry 100, the reference voltage VRef output by the reference voltage generator circuitry 230 is referenced to the voltage BST_SW at the node 126. During the discharging phase of operation of the boost converter circuitry 100, when sensing of the current through the high-side switch 130 may be required, the reference voltage VRef output by the reference voltage generator circuitry 230 is referenced to the reference voltage gndp at the reference voltage rail 236.

In the example shown in FIG. 2, an output of the comparator circuitry 240 is coupled to a first input of on-off (or “bang bang”) controller circuitry 240. A second input of the on-off controller circuitry 240 receive a signal min_pulse indicative of a minimum charging pulse duration for the bootstrap capacitor 140 per operational cycle of the boost converter circuitry 100.

An output of the on-off controller circuitry 240 is coupled, in the example shown in FIG. 2, to an input of first level shifter circuitry 250 and to an input of time-to-voltage converter circuitry 260.

An output of the first level shifter circuitry 250 is coupled to a control input (e.g. a gate terminal) of the charging switch 212, such that operation of the charging switch 212 is controlled by the output of the first level shifter circuitry 250.

An output of the time-to-voltage converter circuitry 260 is coupled to an input of hysteresis buffer circuitry 270. An output of the hysteresis buffer circuitry is coupled to an input of second level shifter circuitry 280.

An output of the second level shifter circuitry 280 is coupled to a control input of the controllable current source circuitry 210, such that an output current of the controllable current source circuitry 210 is controlled by the output of the second level shifter circuitry 280.

The circuitry 200 further includes an overvoltage protection subsystem 290 comprising overvoltage detection circuitry 292 and overvoltage clamp circuitry 294. The overvoltage protection subsystem is configured to prevent the voltage across the bootstrap capacitor 140 from exceeding a predefined level.

The overvoltage detection circuitry 292 comprises comparator circuitry having a first input coupled to the node 216 and a second input coupled to receive an overvoltage reference voltage OVRef. An output of the overvoltage detector circuitry 292 is coupled to a control input of the overvoltage clamp circuitry 294.

The overvoltage clamp circuitry comprises a clamp switch such as a MOSFET coupled between the node 216 and the reference voltage rail 236. A control terminal (e.g. a gate terminal) of the switch is coupled to the output of the overvoltage detector circuitry 292.

In operation of the circuitry 200, operation of the switch 218 is synchronised with operation of the low-side switch 120 of the boost converter circuitry 100, such that the switch 218 is closed (switched on) to couple the node 216 to the first input of the comparator circuitry 220 when the low-side switch 120 of the boost converter circuitry 100 is switched on. Operation of the switch 218 is thus synchronised with the operational cycle of the boost converter circuitry 100.

The comparator circuitry 220 is operative to compare the voltage at the node 216 to the reference voltage VRef received at its second input, which is referenced to the voltage BST_SW at the node 126 when the low-side switch 120 of the boost converter circuitry 100 is switched on.

While the voltage at the node 216 is lower than the reference voltage VRef, an output voltage at the output of the comparator circuitry 220 is high (e.g. greater than 0V). When the voltage at the node 216 is equal to the reference voltage VRef, the output voltage of the comparator circuitry 220 goes low (e.g. 0V), and remains low while the voltage at the node 216 is equal to or greater than the reference voltage VRef.

Because the reference voltage VRef is referenced to the voltage BST_SW at the node 126, the reference voltage VRef changes as the voltage BST_SW at the node changes, such that the reference voltage VRef accurately represents a predefined target minimum voltage across the bootstrap capacitor 140 regardless of any change in the voltage BST_SW at the node 126. This allows accurate charging of the bootstrap capacitor 140 to the predefined target minimum voltage irrespective of the voltage BST_SW at the node 126.

The on-off controller circuitry 240 receives the output voltage of the comparator circuitry 220 at its first input. While the output voltage of the comparator circuitry 220 is high, the on-off controller circuitry 240 outputs a high (e.g. logic level 1) output signal to the first level shifter circuitry 250 and also to the time-to-voltage converter circuitry 260. When the output voltage of the comparator circuitry 220 goes low, the output of the on-off controller circuitry 240 also goes low (e.g. logic level 0).

The on-off controller circuitry 240 also receives the signal min_pulse indicative of the minimum charging pulse duration. The on-off controller circuitry 240 is configured to output a high (e.g. logic level 1) output signal to the first level shifter circuitry 250 for the minimum charging pulse duration, beginning when the low-side switch 120 of the boost converter circuitry 100 closes, regardless of the level of the output voltage of the comparator circuitry 220. If the level of the output voltage of the comparator circuitry 240 remains high beyond the end of the minimum charging pulse duration, the on-off controller circuitry 240 continues to output a high output signal until the output voltage of the comparator circuitry 220 goes low.

Thus, the output of the on-off control circuitry 240 is a high or positive pulse of a duration equal to either the period for which the output of the comparator circuitry 220 is high or the minimum charging pulse duration indicated by the signal min_pulse, whichever of those two periods is longer. This arrangement ensures that the bootstrap capacitor 140 receives charging current from the controllable current source circuitry 210 for at least the minimum charging pulse duration once per operational cycle of the boost converter circuitry 100, which helps to maintain loop stability in the boost converter circuitry 100.

The first level shifter circuitry 250 receives the output signal of the on-off control circuitry 240 and outputs a switch control signal, based on the output signal of the on-off control circuitry 240, to the control terminal of the charging switch 212. When the output of the on-off control circuitry 240 is low, a magnitude of the switch control signal is sufficiently low (e.g. 0V) as to ensure that the charging switch 212 is fully switched off. When the output of the on-off control circuitry 240 is high, the magnitude of the switch control signal is sufficiently high (e.g. 5V) as to ensure that the charging switch 212 is fully switched on. (It will be appreciated by those of ordinary skill in the art that the first level shifter circuitry could be omitted in other examples, if the on-off control circuitry 240 is configured to output an output signal of a magnitude that is sufficient to switch the charging switch 212 completely on or completely off as necessary.)

Thus, while the low-side switch 120 is switched on and the voltage at the node 216 is lower than the reference voltage VRef (indicating the voltage across the bootstrap capacitor 140 is lower than the reference voltage VRef), or alternatively for the duration of the minimum pulse period, the charging switch 212 is closed, allowing current to flow from the controllable current source circuitry 210 to the bootstrap capacitor 140 to charge the bootstrap capacitor 140. Using the controllable current source circuitry 210 enables more accurate charging of the bootstrap capacitor 140 than a voltage-based charging arrangement, as voltage-based charging arrangements can result in large errors, especially when the on-time of the low-side switch 120 is short. Thus, charging the bootstrap capacitor 140 using the controllable current source circuitry 210 helps to ensure that the bootstrap capacitor 140 is charged to a desired level with a high degree of accuracy.

Once the voltage at the node 216 is equal to the reference voltage VRef (indicating that the voltage across the bootstrap capacitor 140 has reached the reference voltage VRef and thus that the bootstrap capacitor 140 has charged to at least the predefined target minimum voltage), or alternatively once the minimum pulse period has elapsed, the charging switch 212 is opened, thus preventing further current from flowing from the controllable current source circuitry 210 to the bootstrap capacitor 140 until the next charging cycle of the boost converter circuitry 100.

As will be appreciated by those of ordinary skill in the art, the combination of the comparator circuitry 220 and reference voltage generator circuitry 230 (and the on-off controller circuitry 240, if provided) constitutes control circuitry for controlling operation of the charging switch 212 to charge the bootstrap capacitor 140 to at least the predefined minimum target voltage.

The time-to-voltage converter circuitry 260 receives the output signal of the on-off controller circuitry 240, and outputs a voltage indicative of the duration of the high or positive pulse output by the on-off controller circuitry 240 (e.g. the duration between a rising edge of the high or positive pulse and a falling edge of the high or positive pulse), which is output to the hysteresis buffer circuitry 270. A magnitude of the voltage output by the time-to-voltage converter circuitry 260 may be proportional to the duration of the high or positive pulse output by the on-off controller circuitry 240, such that a longer high or positive pulse output by the on-off controller circuitry 240 will cause the time-to-voltage converter circuitry 260 to output a higher voltage than it would for a shorter high or positive pulse.

The hysteresis buffer circuitry 270 receives the voltage output signal of the time-to-voltage converter circuitry 260 and outputs a hysteresis buffer output signal to the second level shifter circuitry 280. The hysteresis buffer circuitry 270 applies hysteresis to the output of the time-to-voltage converter circuitry 260 to prevent small or transient changes in the output voltage of the time-to-voltage converter circuitry 260 from affecting the current output by the controllable current source circuitry 210.

The second level shifter circuitry 280 receives the hysteresis buffer output signal and outputs a current source control signal (e.g. a voltage) of a suitable magnitude for controlling the controllable current source circuitry 210, based on the hysteresis buffer output signal, to a control terminal of the controllable current source circuitry 210.

A magnitude of the output current output by the controllable current source circuitry 210 is dependent upon the current source control signal. For example, the magnitude of the output current may be inversely proportional to a magnitude of the current source control signal, such that a lower magnitude current source control signal will cause the controllable current source circuitry 210 to output a higher current than it would for a higher magnitude current source control signal.

The controllable current source circuitry 210 and time to voltage converter circuitry 260 (in combination with the hysteresis buffer 270 and second level shifter circuitry 280, if provided) constitute a dynamic charge pump which is adaptive to variations in the duty cycle of the boost converter circuitry 100, in the sense that the output current of the controllable current source changes in response to a change in the duty cycle of the boost converter circuitry 100. For example, a lower current may be supplied to the bootstrap capacitor 140 in the charging phase of the operational cycle of the boost converter circuitry 100 that immediately follows a reduction in the duty cycle (where the low-side switch 120 is switched on for a longer period) and a higher current may be supplied to the bootstrap capacitor 140 in the charging phase of the operational cycle of the boost converter circuitry 100 that immediately follows an a decrease in the duty cycle (where the low-side switch 120 is switched on for a shorter period).

By controlling the output current of the controllable current source circuitry 210 in this way, a shorter period in which the bootstrap capacitor 140 can be charged (resulting from an increase in the duty cycle of the boost converter circuitry 100) can be compensated, in subsequent operational cycles of the boost converter circuitry 100, by a higher charging current supplied by the controllable current source circuitry 210, such that at least a predetermined minimum amount of charge can be supplied to the bootstrap capacitor 140 per cycle of the boost converter circuitry 100 regardless of a change in the duty cycle of the boost converter circuitry 100.

Charging of the bootstrap capacitor 240 is synchronised with the charging phase of the operational cycle of the boost converter circuitry 100 (since charging of the bootstrap capacitor 140 occurs only when the low-side switch 120 is switched on and the high-side switch 130 is switched off in the charging phase). This synchronisation prevents the occurrence of undertones at frequencies below the switching frequency of the boost converter circuitry 100.

The overvoltage protection subsystem 290 provides protection against overcharging of the bootstrap capacitor 140 (i.e. charging the bootstrap capacitor 140 to a voltage that is significantly greater than predefined target voltage).

To this end, in operation of the circuitry 200, the overvoltage detection circuitry 292 is operative to compare the voltage at the node 216 to the overvoltage reference voltage OVRef. While the voltage at the node 216 is less than the overvoltage reference voltage OVRef, the output of the overvoltage protection circuitry 292 remains low. If the voltage at the node 216 reaches or exceeds the overvoltage reference voltage OVRef, the output of the overvoltage detection circuitry 292, goes high, causing the clamp switch of the overvoltage clamp circuitry 294 clamp the node 216 to the reference voltage rail 236 (or some other voltage that will not damage downstream circuitry). The output of the overvoltage detection circuitry 292 may also be coupled to control circuitry (not shown in FIG. 2), such that a change from low to high in the output of the overvoltage detection circuitry 292 can be used as a flag to signal a fault to the control circuitry.

In the example described above with reference to FIG. 2, the charging circuitry 200 comprises high-impedance current source circuitry 210 for supplying a charging current to charge the bootstrap capacitor 140. As noted above, this arrangement permits more accurate charging of the bootstrap capacitor 140 to a desired level than a voltage-based charging arrangement. However, it will be appreciated by those of ordinary skill in the art that alternative circuitry may be used in place of the current source circuitry 210 to charge the bootstrap capacitor 140, for example capacitive charge pump circuitry. Such alternative circuitry may also be adaptive, in the sense that the amount of charge supplied to the bootstrap capacitor 140 may be adapted responsive to a charging in the time available for charging the bootstrap capacitor 140 in an operational cycle of the boost converter circuitry 100, e.g. as a result of a change in the duty cycle of the boost converter circuitry 100.

In the example described above with reference to FIG. 2, the charging circuitry 200 is for charging a bootstrap capacitor 140 associated with the high-side switch 130 of the boost converter circuitry 100. It will be appreciated, however, that the charging circuitry 200 of FIG. 2 could, additionally or alternatively, be employed to charge a bootstrap capacitor associated with the low-side switch 120 of the boost converter circuitry 100.

Moreover, the charging circuitry 200 described above with reference to FIG. 2 is equally suitable for charging a bootstrap capacitor of a switch (high-side and/or low-side) of other types of switching circuitry, including (but not limited to) switching power converter circuitry, switching boost converter circuitry, switching buck converter circuitry, switching buck-boost converter circuitry, switching AC-DC converter circuitry, switching DC-AC converter circuitry, or switching amplifier circuitry (e.g. Class D amplifier circuitry).

The circuitry described above with reference to the accompanying drawings may be incorporated in a host device such as a laptop, notebook, netbook or tablet computer, a gaming device such as a games console or a controller for a games console, a virtual reality (VR) or augmented reality (AR) device, a mobile telephone, a portable audio player or some other portable device, or may be incorporated in an accessory device for use with a laptop, notebook, netbook or tablet computer, a gaming device, a VR or AR device, a mobile telephone, a portable audio player or other portable device.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog TM or VHDL (Very high speed integrated circuit Hardware Description Language). As the skilled person will appreciate, the code may be distributed between a plurality of coupled components in communication with one another. Where appropriate, the embodiments may also be implemented using code running on a field-(re) programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general purpose processor or the like. A module may itself comprise other modules or functional units. A module may be provided by multiple components or sub-modules which need not be co-located and could be provided on different integrated circuits and/or running on different processors.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. Charging circuitry for charging a bootstrap capacitor that provides a gate drive voltage to a high-side switch of switching circuitry, wherein a first terminal of the bootstrap capacitor receives a variable voltage, the charging circuitry comprising:
current source circuitry configured to supply a charging current to the bootstrap capacitor;
a charging switch for selectively coupling the current generator circuitry to the bootstrap capacitor to permit charging of the bootstrap capacitor by the current generator circuitry; and
control circuitry configured to control operation of the charging switch to charge the bootstrap capacitor to at least a predefined target voltage, wherein the predefined target voltage is referenced to the variable voltage.

2. The charging circuitry of claim 1, wherein the control circuitry comprises comparator circuitry configured to compare a signal indicative of a voltage at a second terminal of the bootstrap capacitor to a reference signal indicative of the predefined target voltage and to output a comparator output signal based on the comparison, wherein:
responsive to the comparator circuitry outputting a comparator output signal indicative that the voltage at the second terminal of the bootstrap capacitor is less than the predefined target voltage, the control circuitry causes the charging switch to close to permit charging of the bootstrap capacitor by the current generator circuitry; and
responsive to the comparator circuitry outputting a comparator output signal indicative that the voltage at the second terminal of the bootstrap capacitor is equal to or greater than the predefined target voltage, the control circuitry causes the charging switch to open to prevent charging of the bootstrap capacitor by the current generator circuitry.

3. The charging circuitry of claim 2, wherein:
the signal indicative of the voltage at the second terminal of the bootstrap capacitor comprises the voltage at the second terminal of the bootstrap capacitor; and
the reference signal indicative of the predefined target voltage comprises the predefined target voltage.

4. The charging circuitry of claim 3, further comprising a comparator switch for coupling a first input of the comparator circuitry to the second terminal of the bootstrap capacitor, wherein operation of the comparator switch is synchronised with an operational cycle of the switching circuitry.

5. The charging circuitry of claim 2, wherein the control circuitry further comprises on-off controller circuitry configured to receive the comparator output signal and to output a pulse of a duration equal to a period for which the comparator output signal is indicative that the voltage at the second terminal of the bootstrap capacitor is less than the predefined target voltage, wherein the control circuitry is operative to cause the charging switch to close for the duration of the pulse.

6. The charging circuitry of claim 5, wherein the on-off controller circuitry is further configured to receive a signal indicative of a minimum charging pulse duration for the bootstrap capacitor and to output a pulse of a duration equal to the longer of:
a period for which the comparator output signal is indicative that the voltage at the second terminal of the bootstrap capacitor is less than the predefined target voltage; and
the minimum charging pulse duration.

7. The charging circuitry of claim 5, wherein the control circuitry further comprises time to voltage converter circuitry configured to:
receive the pulse output by the on-off control circuitry; and
output a voltage indicative of the duration of the pulse for controlling a magnitude of the charging current output by the current source circuitry.

8. The charging circuitry of claim 7, further comprising a comparator switch for coupling a first input of the comparator circuitry to the second terminal of the bootstrap capacitor, wherein operation of the comparator switch is synchronised with an operational cycle of the switching circuitry, and wherein the time to voltage converter is configured to increase the charging current output by the current source circuitry responsive to a reduction in a duration of a charging period of the bootstrap capacitor in the operational cycle of the switching circuitry.

9. The charging circuitry of claim 7, wherein the control circuitry further comprises hysteresis buffer circuitry configured to receive the voltage output by the time to voltage converter circuitry.

10. The charging circuitry of claim 1, further comprising an overvoltage protection subsystem, the overvoltage protection subsystem comprising:
overvoltage detection circuitry configured to compare a signal indicative of a voltage at a second terminal of the bootstrap capacitor to an overvoltage reference signal; and
overvoltage clamp circuitry operative to couple the second terminal of the bootstrap capacitor to a reference voltage supply rail.

11. Switching circuitry comprising the charging circuitry of claim 1, wherein the switching circuitry comprises switching power converter circuitry, switching boost converter circuitry, switching buck converter circuitry, switching buck-boost converter circuitry, switching AC-DC converter circuitry, switching DC-AC converter circuitry, or switching amplifier circuitry.

12. A host device comprising the charging circuitry of claim 1.

13. The host device of claim 12, wherein the host device comprises a laptop, notebook, netbook or tablet computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console a VR or AR device, a mobile telephone, a portable audio player or other portable device.

14. An integrated circuit comprising the charging circuitry of claim 1.

15. Charging circuitry for charging a bootstrap capacitor of switching power converter circuitry, wherein the charging circuitry comprises control circuitry operative to synchronise charging of the bootstrap capacitor with an operational cycle of the switching power converter circuitry.

16. Charging circuitry for charging a bootstrap capacitor of switching circuitry, the charging circuitry comprising adaptive charge pump circuitry configured to adapt a level of charge supplied to the bootstrap capacitor according to a duty cycle of the switching circuitry.

17. Charging circuitry for charging a bootstrap capacitor of switching circuitry, the charging circuitry comprising:
a controllable current source for supplying a charging current to the bootstrap capacitor; and
control circuitry,
wherein the control circuitry is configured to control the controllable current source based on a duty cycle of the switching circuitry to ensure a minimum level of charge is supplied to the bootstrap capacitor per operational cycle of the switching circuitry.

18. Charging circuitry for charging a bootstrap capacitor of switching circuitry, the charging circuitry comprising control circuitry operative to supply one charging pulse to the bootstrap capacitor per operational cycle of the switching circuitry.

19. The charging circuitry of claim 18, wherein the control circuitry is operative to supply one charging pulse of at least a minimum duration to the bootstrap capacitor per operational cycle of the switching circuitry.
